(19) United States
(12) Patent Application Publication
(10) Pub. No.: US 2023/0154367 A1
(43) Pub. Date: May 18, 2023

(54) DATA DRIVING CHIP AND DISPLAY DEVICE

(71) Applicant: TCL China Star Optoelectronics Technology Co., Ltd., Shenzhen, Guangdong (CN)

(72) Inventor: Jinfeng LIU, Shenzhen, Guangdong (CN)

(73) Assignee: TCL China Star Optoelectronics Technology Co., Ltd., Shenzhen, Guangdong (CN)

(21) Appl. No.: 17/251,882

(22) PCT Filed: Dec. 4, 2020
(86) PCT No.: PCT/CN2020/133840

§ 371 Date: Dec. 14, 2020

(30) Foreign Application Priority Data
Nov. 27, 2020 (CN) 202011351555.2

(51) Int. Cl. G09G 3/20

(52) U.S. Cl. CPC G09G 3/20; G09G 2310/0272; G09G 2310/08; G09G 2330/021

(57) ABSTRACT

A data driving chip and a display device are provided. The data driving chip includes a latch module configured to receive current display data and latch the current display data, and after the current display data is latched, output the current display data. An output module is configured to output the current display data outputted by the latch module to a display panel. The latch module is further configured to clear the current display data latched in the latch module when the output module outputs the current display data.

### RELATED APPLICATIONS

This application is a National Phase of PCT Patent Application No. PCT/CN2020/133840 having International filing date of Dec. 4, 2020, which claims the benefit of priority of Chinese Patent Application No. 202011351555.2 filed on Nov. 27, 2020. The contents of the above applications are all incorporated by reference as if fully set forth herein in their entirety.

### FIELD AND BACKGROUND OF THE INVENTION

The present invention relates to the field of display technologies, and in particular to a data driving chip and a display device.

In current technologies, a data driving chip usually comprises two sets of latch modules: a first set of latch modules and a second set of latch modules. The first set of latch modules is configured to latch an N−1^{th} row of display data when an N−1^{th} rising edge of a control signal is approached. The first set of latch modules is further configured to transfer the N−1^{th} row of the display data to the second set of latch modules when an Nth rising edge of the control signal approaches, and start to receive an Nth row of the display data. Wherein, N is a positive integer greater than 1. Since the N−1^{th} row of the display data is stored in the second set of latch modules, when an Nth falling edge of the control signal approaches, the second set of latch modules output the N−1^{th} to row of the display data to the display panel.

In current technologies, a data driving chip uses a first set of latch modules and a second set of latch modules to achieve a purpose of latching an Nth row of display data on a rising edge of a control signal and outputting an N−1^{th} row of the display data on a falling edge of the control signal. However, two sets of latch modules need to be provided in the data driving chip to cooperate with each other to output the display data, which causes a problem of a larger size of the data driving chip.

### SUMMARY OF THE INVENTION

The present application provides a data driving chip and a display device to solve a technical problem of a large size of a data driving chip in the prior art.

The present application provides a data driving chip comprising:

a latch module configured to receive current display data and latch the current display data, wherein after the current display data is latched, output the current display data; and

an output module configured to output the current display data output by the latch module to a display panel;

wherein the latch module is further configured to clear the current display data latched in the latch module when the output module outputs the current display data.

In the data driving chip provided by the present application, the latch module accesses a reset control signal, the reset control signal is configured to act on the latch module within a reset time period, so that the latch module clears the current display data in the latch module.

In the data driving chip provided by the present application, the latch module accesses an output control signal, the output control signal is configured to act on the latch module within an output time period, so that the latch module outputs the current display data to the output module.

In the data driving chip provided by the present application, the reset control signal and the output control signal are both provided by a timing controller.

In the data driving chip provided by the present application, the latch module is specifically configured to latch the current display data before a current rising edge of a clock signal approaches, and output the current display data after the current display data latched; and

the output module is specifically configured to receive the current display data output by the latch module before the current rising edge of the clock signal approaches, and output the current display data to the display panel when the current rising edge of the clock signal is approaching.

In the data driving chip provided by the present application, the reset time period is disposed corresponding to a current falling edge of the clock signal, and the output time period is disposed corresponding to the current rising edge of the clock signal.

In the data driving chip provided by the present application, the latch module is configured to access the reset control signal when the current rising edge of the clock signal approaches or after the current rising edge of the clock signal approaches.

In the data driving chip provided by the present application, the current display data comprises a plurality of data signals, and

the latch module is specifically configured to receive a latch control clock signal and receive one data signal at each rising edge and each falling edge of the latch control clock signal, and the latch module latches the data signal after receiving each data signal.

In the data driving chip provided by the present application, the latch module is further configured to, after clearing the current display data in the latch module, latch next display data when the rising edge of the latch control clock signal approaches.

In the data driving chip provided by the present application, the output module is further configured to output a feedback signal to the latch module after the output module outputs the current display data, so that the latch module clears the current display data in the latch module.

Correspondingly, the present application further provides a display device comprising a data driving chip, wherein the data driving chip comprises:

a latch module configured to receive current display data and latch the current display data, wherein after the current display data is latched, output the current display data; and

an output module configured to output the current display data output by the latch module to a display panel;

wherein the latch module is further configured to clear the current display data latched in the latch module when the output module outputs the current display data.

In the display device provided by the present application, the latch module accesses a reset control signal, the reset control signal is configured to act on the latch module within a reset time period, so that the latch module clears the current display data in the latch module.

In the display device provided by the present application, the latch module accesses an output control signal, the output control signal is configured to act on the latch module within an output time period, so that the latch module outputs the current display data to the output module.

In the display device provided by the present application, the reset control signal and the output control signal are both provided by a timing controller.

In the display device provided by the present application, the latch module is specifically configured to latch the current display data before a current rising edge of a clock signal approaches, and output the current display data after the current display data latched; and

the output module is specifically configured to receive the current display data output by the latch module before the current rising edge of the clock signal approaches, and output the current display data to the display panel when the current rising edge of the clock signal is approaching.

In the display device provided by the present application, the reset time period is disposed corresponding to a current falling edge of the clock signal, and the output time period is disposed corresponding to the current rising edge of the clock signal.

In the display device provided by the present application, the latch module is configured to access the reset control signal when the current rising edge of the clock signal approaches or after the current rising edge of the clock signal approaches.

In the display device provided by the present application, the current display data comprises a plurality of data signals, and

the latch module is specifically configured to receive a latch control clock signal and receive one data signal at each rising edge and each falling edge of the latch control clock signal, and the latch module latches the data signal after receiving each data signal.

In the display device provided by the present application, the latch module is further configured to, after clearing the current display data in the latch module, latch next display data when the rising edge of the latch control clock signal approaches.

In the display device provided by the present application, the output module is further configured to output a feedback signal to the latch module after the output module outputs the current display data, so that the latch module clears the current display data in the latch module.

A data driving chip provided by the present application configures a latch module to clear current display data latched in the latch module when an output module outputs the current display data, so that the latch module can latch next display data and the data driving chip can output the current display data without setting two sets of latch modules. Therefore, compared with the prior art, the number of latch modules in the data driving chip provided by the present application is greatly reduced, thereby effectively reducing a size of the data driving chip. Meanwhile, since a transmission path of the current display data in the data driving chip is simplified, a transmission rate of the current display data is improved.

### BRIEF DESCRIPTION OF THE SEVERAL VIEWS OF THE DRAWINGS

In order to more clearly illustrate the embodiments or the technical solutions in the prior art, a brief introduction of the drawings used in the embodiments or the prior art description will be briefly described below. Obviously, the drawings in the following description are only some of the embodiments of the invention, and those skilled in the art can obtain other drawings according to the drawings without any creative work.

FIG. 1 is a schematic view of a first structure of a display device provided by the present application.

FIG. 2 is a timing view of a first signal in a data driving chip provided by the present application.

FIG. 3 is a schematic view of a latching method of a latch module provided by the present application.

FIG. 4 is a timing view of a second signal in the data driving chip provided by the present application.

FIG. 5 is a schematic view of a second structure of the display device provided by the present application.

### DESCRIPTION OF SPECIFIC EMBODIMENTS OF THE INVENTION

The following will clearly and completely describe the technical solutions in the embodiments of the present invention with reference to the drawings in the embodiments of the present invention. Obviously, the described embodiments are only a part of the embodiments of the present invention, rather than all the embodiments. Based on the embodiments in the present invention, all other embodiments obtained by those skilled in the art without creative work are within the protection scope of the present invention.

The present application provides a display device, which can be a smartphone, a tablet computer, an e-book reader, a smartwatch, a video camera, a game console, etc., which is not limited in the present application.

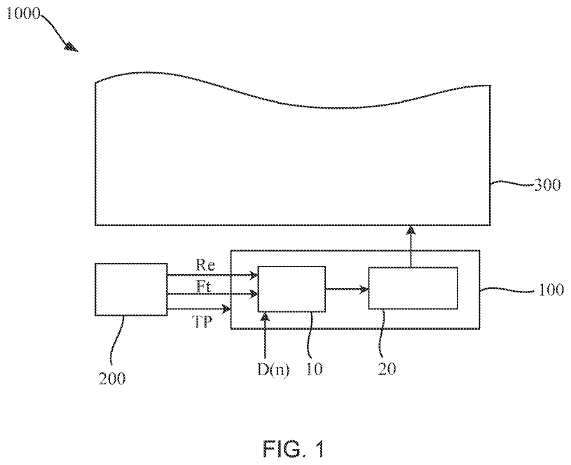

Please refer to FIG. 1. FIG. 1 is a schematic view of a first structure of the display device provided by the present application. As shown in FIG. 1, the display device 1000 provided by an embodiment of the present application comprises a data driving chip 100, a timing controller 200, and a display panel 300.

The timing controller 200 is configured to provide timing control signals to the data driving chip 100. The data driving chip 100 is configured to provide display data to the display panel 300 to drive the display panel 300 for screen display.

The data driving chip 100 can be directly attached to a substrate of the display panel 300, or it can be bound to the display panel 300 through a flip chip film, which is not specifically limited in the present application.

The number of data driving chips 100 may be one or more, which may be specifically set according to a pixel resolution of the display panel 300 and is not specifically limited in the present application.

Further, the data driving chip 100 provided in the embodiments of the present application comprises a latch module 10 and an output module 20. The latch module 10 is configured to receive current display data D(n) and latch the current display data D(n). After the current display data D(n) is latched, it is outputted. The output module 20 is configured to output the current display data D(n) output by the latch module 10 to the display panel 300. Wherein, the latch module 10 is further configured to clear the current display data D(n) latched in the latch module 10 when the output module 20 outputs the current display data D(n).

It can be seen that, in the data driving chip 100 provided by the embodiment of the present application, by configuring the latch module 10 to clear the current display data D(n) latching in the latch module 10 when the output module 20 outputs the current display data D(n) to the display panel 300, the latch module 10 can continue to latch next display data after clearing the current display data D(n). That is, in the data driving chip 100 provided by the present application, only one set of latch modules 10 is needed to achieve latching and transmission of multiple rows of the display data, so that the number of latch modules 10 is greatly reduced, which can effectively reduce a size of the data driving chip 100. Meanwhile, since a transmission path of the current display data D(n) in the data driving chip 100 is simplified, time required for secondary transmission is reduced, thereby increasing a transmission rate of the current display data D(n).

In the data driving chip 100 provided by the embodiments of the present application, the number of latch module 10 and output module 20 can be set according to specifications of the data driving chip 100 or the pixel resolution of the display panel 300, which is not specifically limited in the present application.

In the embodiment of the present application, the output module 20 may comprise a level converter, a digital-to-analog converter, and an analog buffer amplifier. The level converter is configured to convert a power supply voltage into a suitable working voltage for the digital-to-analog converter. The digital-to-analog converter is configured to convert the current display data D(n) into an analog signal based on a gray-scale voltage. The analog buffer amplifier is configured to amplify a simulated current display data D(n) and output it to the display panel 300.

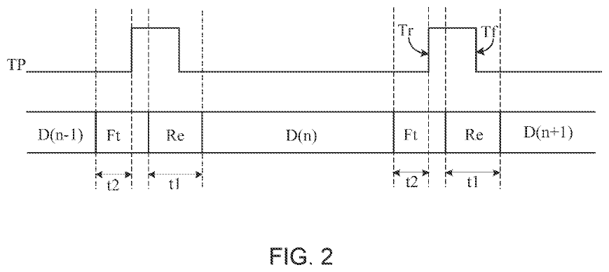

Please refer to FIG. 2. FIG. 2 is a timing view of a first signal in the data driving chip provided by the present application. Combining FIG. 1 and FIG. 2, it can be seen that in the present application, the data driving chip 100 receives a clock signal TP. The latch module 10 is configured to latch the current display data D(n) before a current rising edge Tr of the clock signal TP approaches and output the current display data D(n) after the current display data D(n) is latched. The output module 20 is configured to receive the current display data D(n) outputted by the latch module 10 before the current rising edge Tr of the clock signal TP approaches and output the current display data D(n) to the display panel 300 when the current rising edge Tr of the clock signal TP is approaching. Wherein, the clock signal TP can be provided by the timing controller 200.

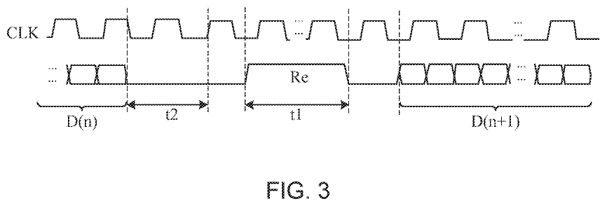

Specifically, please refer to FIG. 3. FIG. 3 is a schematic view of a latching method of the latch module provided by the present application. As shown in FIG. 3, in the embodiment of the present application, the current display data D(n) comprises a plurality of data signals. The latch module 10 is specifically configured to receive a latch control clock signal CLK and receive a data signal at each rising edge and each falling edge of the latch control clock signal CLK. After the latch module 10 receives a data signal, it latches the data signal. That is, in the embodiment of the present application, the latch module 10 is configured to latch the current display data D(n) in a transmission edge latching method. The latching method can effectively increase latching speed of the latch module 10, thereby improving work efficiency of the data driving chip 100.

It should be noted that, in the embodiments of the present application, the latch module 10 is further configured to, after clearing the current display data D(n) in the latch module 10, latch next display data D(n+1) when the rising edge of the latch control clock signal CLK approaches, which ensures that the latch module 10 starts to latch the next display data D(n+1) after the current display data D(n) is completely cleared, to prevent data latch errors.

In addition, the clock signal TP is only configured to trigger the output module 20 at the current rising edge Tr, so that the output module 20 outputs the current display data D(n) to the display panel 300. Therefore, the embodiment of the present application does not need to limit a pulse width of the clock signal TP. In addition, outputting the clock signal TP with a narrow pulse width can reduce power consumption of the timing controller 200.

Further, in the embodiment of the present application, the latch module 10 accesses an output control signal Ft. The output control signal Ft is configured to act on the latch module 10 during an output time period t2, so that after the latch module 10 finishes latching the current display data D(n), it can respond to the output control signal Ft to output the current display data D(n) to the output module 20.

Wherein, before the current rising edge Tr of the clock signal TP approaches, the latch module 10 can completely transmit the current display data D(n) to the output module 20 within the output time period t2. Therefore, the embodiments of the present application do not specifically limit a duration of the output time period t2.

In the embodiments of the present application, the latch module 10 accesses a reset control signal Re. The reset control signal Re is configured to act on the latch module 10 during the reset time period t1, so that the latch module 10 clears the current display data D(n) latched therein.

Wherein, in the reset time period t1, the latch module 10 can completely clear the current display data D(n) latched therein. Therefore, the embodiment of the present application does not specifically limit a duration of the reset time period t1.

It should be noted that, ideally, the output module 20 can completely output the current display data D(n) to the display panel 300 when the current rising edge Tr of the clock signal TP is approaching, and an output time is negligible. However, considering an impedance of signal traces and other influencing factors, there may be a certain delay in time when the output module 20 outputs the current display data D(n). Therefore, by setting the reset time period t1 (i.e., setting the reset control signal Re) in the embodiments of the present application, it can provide a delay time required for the output module 20 to output the current display data D(n) to the display panel 300 while the latch module 10 completely clears the current display data D(n) latched therein.

Further, in the embodiments of the present application, the output time period t2 is set corresponding to the current rising edge Tr of the clock signal TP, and the reset time period t1 is set corresponding to a current falling edge Tf of the clock signal TP.

It is understandable that the latch module 10 needs to latch all the current display data D(n) before the current rising edge Tr of the clock signal TP approaches and transmit it to the output module 20. Therefore, an end node of the output time period t2 needs to be located before an arrival of the current rising edge Tr of the clock signal TP or at the current rising edge Tr of the clock signal TP. Similarly, since the embodiments of the present application does not need to limit the pulse width of the clock signal TP, an end node of the reset time period t1 can be located before, during or after the current falling edge Tf of the clock signal TP.

In addition, in the embodiments of the present application, there is no need to limit a timing relationship between the current rising edge Tr of the clock signal TP and a start node of the corresponding reset control signal Re, thereby simplifying the timing of the signals in the data driving chip 100 and reducing design difficulty.

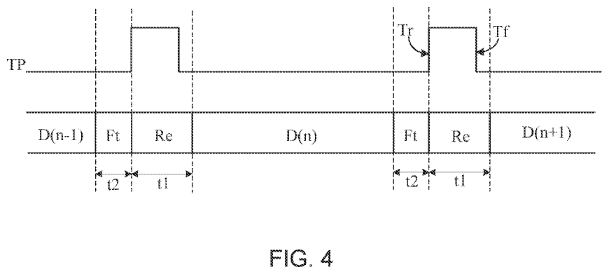

Specifically, in some embodiments of the present application, the latch module 10 may access the reset control signal Re after the current rising edge Tr of the clock signal TP approaches, as shown in FIG. 2. Of course, in some other embodiments of the present application, the latch module 10 can access the reset control signal Re when the current rising edge Tr of the clock signal TP is approaching, as shown in FIG. 4.

It should be noted that, in the embodiments of the present application, the reset control signal Re and the output control signal Ft are both provided by the timing controller 200. The current display data D(n) can be provided by a system chip (not shown in the drawings) or the timing controller 200. Wherein, a structure and a working principle of the system chip and the timing controller 200 are all technologies well known to those skilled in the art, and will not be repeated here.

Based on the embodiments of the present application, a data transmission method of the data driving chip 100 comprises following steps: The latch module 10 latches the current display data D(n) before the current rising edge Tr of the clock signal TP approaches; after the current display data D(n) is latched, the latch module 10 outputs the current display data D(n) within the output time period t2; the output module 20 outputs the current display data D(n) to the display panel 300 when the current rising edge Tr of the clock signal TP is approaching; and when the output module 20 outputs the current display data D(n), the latch module 10 clears the current display data D(n) latched therein within the reset time period t1 based on the reset control signal Re. The data driving chip 100 realizes the transmission of multiple rows of the display data through the above-mentioned data transmission method.

Wherein, the latch module 10 has completed the step of clearing the previous display data D(n−1) latched therein before latching the current display data D(n), and after completing the step of clearing the current display data D(n) latched therein, the latch module 10 will further latch the next display data D(n+1) before the next rising edge of the clock signal TP arrives. Wherein, n is a positive integer greater than 1.

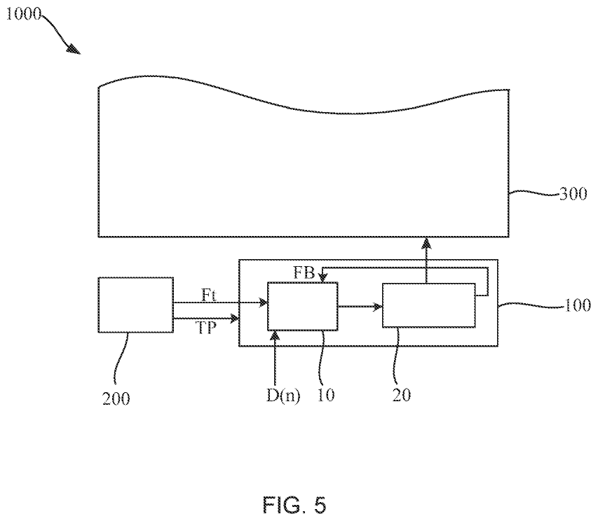

Please refer to FIG. 5. FIG. 5 is a schematic view of a second structure of the display device provided by the present application. A difference between the display device 1000 shown in FIG. 5 and the display device 1000 shown in FIG. 1 is that in the data driving chip 100 of the display device 1000 shown in FIG. 5, the output module 20 is further configured to output a feedback signal FB to the latch module 10 after it outputs the current display data D(n) to the display panel 300, so that the latch module 10 clears the current display data D(n) latched in the latch module 10.

Specifically, the latch module 10 latches the current display data D(n) before the current rising edge Tr of the clock signal TP approaches; after the current display data D(n) is latched, the latch module 10 outputs the current display data D(n) within the output time period t2; and the output module 20 outputs the current display data D(n) to the display panel 300 when the current rising edge Tr of the clock signal TP is approaching. Wherein, the output module 20 is further configured to output the feedback signal FB to the latch module 10 when outputting the current display data D(n) to the display panel 300, so that when the output module 20 outputs the current display data D(n), the latch module 10 responds to the feedback signal FB and clears the current display data D(n) latched therein during the reset time period t1.

Therefore, the timing controller 200 does not need to provide the reset control signal Re to the latch module 10, which can reduce power consumption of the timing controller 200 and simplify signal transmission between the data driving chip 100 and the timing controller 200. Meanwhile, after the output module 20 outputs the current display data D(n) to the display panel, it immediately outputs the feedback signal FB to the latch module 10, which can reduce a response time of the latch module 10 to clear the current display data D(n) locked therein, thereby improving working efficiency of the data driving chip 100.

The display device 1000 provided by the present application comprises the data driving chip 100. The data driving chip 100 configures the latch module 10 to clear the current display data D(n) latched in the latch module 10 when the output module 10 outputs the current display data D(n), so that the latch module 10 can latch the next display data, and the data driving chip 100 can output the current display data D(n) without disposition of two sets of latch modules 10. Therefore, compared with the prior art, the number of latch modules 10 in the data driving chip 100 provided by the present application is greatly reduced, so that the size of the data driving chip 100 can be effectively reduced. Meanwhile, since the transmission path of the current display data D(n) in the data driving chip 100 is simplified, the transmission rate of the current display data D(n) is increased, thereby improving quality of the display device 1000.

The data driving chip and the display device provided by the present application are introduced in detail above. The article uses specific examples to explain principles and implementation of the present application. The descriptions of the above embodiments are only used to help understand technical solutions and core ideas of the present application. At the same time, for those of ordinary skill in the art, according to the idea of the present application, there will be changes in the specific embodiment and the scope of application. In summary, contents of the specification should not be construed as a limitation of the present application.

What is claimed is:

1. A data driving chip, comprising:
a latch module configured to receive current display data and latch the current display data, wherein after the current display data is latched, output the current display data; and
an output module configured to output the current display data output by the latch module to a display panel;
wherein the latch module is further configured to clear the current display data latched in the latch module when the output module outputs the current display data.

2. The data driving chip as claimed in claim 1, wherein the latch module accesses a reset control signal, the reset control signal is configured to act on the latch module within a reset time period, so that the latch module clears the current display data in the latch module.

3. The data driving chip as claimed in claim 2, wherein the latch module accesses an output control signal, the output control signal is configured to act on the latch module within an output time period, so that the latch module outputs the current display data to the output module.

4. The data driving chip as claimed in claim 3, wherein the reset control signal and the output control signal are both provided by a timing controller.

5. The data driving chip as claimed in claim 3, wherein the latch module is specifically configured to latch the current display data before a current rising edge of a clock signal approaches and output the current display data after the current display data is latched; and
the output module is specifically configured to receive the current display data outputted by the latch module before the current rising edge of the clock signal approaches and output the current display data to the display panel when the current rising edge of the clock signal is approaching.

6. The data driving chip as claimed in claim 5, wherein the reset time period is set corresponding to a current falling edge of the clock signal, and the output time period is set corresponding to the current rising edge of the clock signal.

7. The data driving chip as claimed in claim 5, wherein the latch module is configured to access the reset control signal when the current rising edge of the clock signal approaches or after the current rising edge of the clock signal approaches.

8. The data driving chip as claimed in claim 1, wherein the current display data comprises a plurality of data signals,
the latch module is specifically configured to receive a latch control clock signal and receive one data signal at each rising edge and each falling edge of the latch control clock signal, and the latch module latches the data signal after receiving each data signal.

9. The data driving chip as claimed in claim 8, wherein the latch module is further configured to, after clearing the current display data in the latch module, latch next display data when the rising edge of the latch control clock signal approaches.

10. The data driving chip as claimed in claim 1, wherein the output module is further configured to output a feedback signal to the latch module after the output module outputs the current display data, so that the latch module clears the current display data in the latch module.

11. A display device, comprising:
a data driving chip, wherein the data driving chip comprises:
a latch module configured to receive current display data and latch the current display data, wherein after the current display data is latched, output the current display data; and
an output module configured to output the current display data output by the latch module to a display panel;
wherein the latch module is further configured to clear the current display data latched in the latch module when the output module outputs the current display data.

12. The display device as claimed in claim 11, wherein the latch module accesses a reset control signal, the reset control signal is configured to act on the latch module within a reset time period, so that the latch module clears the current display data in the latch module.

13. The display device as claimed in claim 12, wherein the latch module accesses an output control signal, the output control signal is configured to act on the latch module within an output time period, so that the latch module outputs the current display data to the output module.

14. The display device as claimed in claim 13, wherein the reset control signal and the output control signal are both provided by a timing controller.

15. The display device as claimed in claim 13, wherein the latch module is specifically configured to latch the current display data before a current rising edge of a clock signal approaches and output the current display data after the current display data latched; and
the output module is specifically configured to receive the current display data outputted by the latch module before the current rising edge of the clock signal approaches, and output the current display data to the display panel when the current rising edge of the clock signal is approaching.

16. The display device as claimed in claim 15, wherein the reset time period is set corresponding to a current falling edge of the clock signal, and the output time period is set corresponding to the current rising edge of the clock signal.

17. The display device as claimed in claim 15, wherein the latch module is configured to access the reset control signal when the current rising edge of the clock signal approaches or after the current rising edge of the clock signal approaches.

18. The display device as claimed in claim 11, wherein the current display data comprises a plurality of data signals, and
the latch module is specifically configured to receive a latch control clock signal and receive one data signal at each rising edge and each falling edge of the latch control clock signal, and the latch module latches the data signal after receiving each data signal.

19. The display device as claimed in claim 18, wherein the latch module is further configured to, after clearing the current display data in the latch module, latch next display data when the rising edge of the latch control clock signal approaches.

20. The display device as claimed in claim 11, wherein the output module is further configured to output a feedback signal to the latch module after the output module outputs the current display data, so that the latch module clears the current display data in the latch module.
